(19) United States
(12) Patent Application Publication
(10) Pub. No.: US 2015/0287997 A1
(43) Pub. Date: Oct. 8, 2015

(54) NANOFIBER AND USE THEREOF IN AN ELECTRODE

(71) Applicant: Nanyang Technological University, Singapore (SG)

(72) Inventors: Qing Zhang, Singapore (SG); Qizhen Xiao, Singapore (SG)

(21) Appl. No.: 14/491,773

(22) Filed: Sep. 19, 2014

Related U.S. Application Data
(60) Provisional application No. 61/881,811, filed on Sep. 24, 2013.

(51) Int. Cl. H01M 4/66; H01M 4/70; H01M 4/04; H01M 4/48; H01M 4/52; H01M 4/50; H01M 10/0525; H01M 4/38

(52) U.S. Cl. CPC H01M 4/66; H01M 10/0525; H01M 4/70; H01M 4/38; H01M 4/48; H01M 4/52; H01M 4/50; H01M 4/0426; H01M 4/0428; H01M 4/0438; H01M 2220/30

(57) ABSTRACT

A nanofiber comprising a polymeric fiber, a first layer comprising or consisting of an electrical conductor coated on the polymeric fiber, and a second layer comprising or consisting of an electroactive material selected from the group consisting of silicon, germanium, tin, and combinations thereof coated on the first layer, is provided. A method of preparing the nanofiber and an electrode comprising the nanofiber are also provided.

### CROSS-REFERENCE TO RELATED APPLICATION

This application claims the benefit of priority of U.S. provisional application No. 61/881,811 filed on 24 Sep. 2013, the content of which is incorporated herein by reference in its entirety for all purposes.

### TECHNICAL FIELD

Various embodiments relate to a nanofiber, and use of the nanofiber in an electrode such as an anode for lithium ion batteries.

### BACKGROUND

High capacity and stability of electrical energy storage devices are in strong demand for many applications, of which lithium ion battery is an example. Lithium ion batteries are now the most widely used secondary battery systems for portable electronic devices, due to their high specific energy (100 Wh/Kg to 150 Wh/Kg) and high specific power (150 W/Kg to 250 W/Kg). Compared with other rechargeable battery, the lithium ion battery has energy density which is twice as large as that of the other rechargeable batteries.

A lithium ion battery generally includes a cathode, an anode, and a non-aqueous lithium containing electrolyte. A separator may be disposed between the cathode and the anode. State of the art materials for cathode in lithium ion batteries include lithium cobalt oxide (LiCoO₂), lithium manganese oxide (LiMn₂O₄), lithium iron phosphate (LiFePO₄), and lithium nickel oxide (LiNiO₂). Anodes in lithium ion batteries, on the other hand, typically include graphite based materials, such as carbon black and mesocarbon microbeads.

Performance of lithium ion batteries are limited by low discharge/charge capacities of the graphite based anodes, which have typical values of about 300 mAh/g. This renders its inability to meet demands for higher energy density, higher power density, and longer battery lifespan. Therefore, it is necessary to improve energy storage performance of lithium ion batteries for next generation devices.

In view of the above, there exists a need for an improved material which may be used as electrodes, such as anodes in lithium ion batteries, which overcomes or at least alleviates one or more of the above-mentioned problems.

### SUMMARY

In a first aspect, a nanofiber is provided. The nanofiber comprises
a) a polymeric fiber;
b) a first layer comprising or consisting of an electrical conductor coated on the polymeric fiber; and
c) a second layer comprising or consisting of an electroactive material selected from the group consisting of silicon, germanium, tin, and combinations thereof coated on the first layer.

In a second aspect, a method of preparing a nanofiber is provided. The method comprises
a) providing a polymeric fiber;
b) coating a first layer comprising or consisting of an electrical conductor on the polymeric fiber; and
c) coating a second layer comprising or consisting of an electroactive material selected from the group consisting of silicon, germanium, tin, and combinations thereof on the first layer.

In a third aspect, an electrode is provided. The electrode comprises a nanofiber network, wherein the nanofiber network comprises a polymeric fiber network, wherein each polymeric fiber comprises
a) a first layer comprising or consisting of an electrical conductor coated on the polymeric fiber; and
b) a second layer comprising or consisting of an electroactive material selected from the group consisting of silicon, germanium, tin, and combinations thereof coated on the first layer.

### BRIEF DESCRIPTION OF THE DRAWINGS

The invention will be better understood with reference to the detailed description when considered in conjunction with the non-limiting examples and the accompanying drawings, in which:

FIG. 1A to C are schematic diagrams of the coaxial silicon/nickel/polyvinylidene fluoride (Si/Ni/PVDF) flexible nanofiber membrane. FIG. 1A is a schematic diagram of PVDF nanofiber membrane (“Polymer”). FIG. 1B is a schematic diagram of Ni/PVDF coaxial nanostructure membrane, where Ni is deposited onto surface of PVDF nanofibers by electroless deposition to form the Ni/PVDF coaxial nanostructure membrane (“Ni/Polymer”). FIG. 1C is a schematic diagram of Si/Ni/PVDF coaxial nanofiber membrane, where Si is coated onto surface of Ni/PVDF nanofibers to form the Si/Ni/PVDF coaxial nanofiber membrane (“Si/Ni/Polymer”).

FIGS. 2A-2F show scanning electron microscopy (SEM) and transmission electron microscopy (TEM) images of Si/Ni/PVDF coaxial nanofiber flexible membrane. FIG. 2A shows a SEM image of the PVDF nanofiber membrane. FIG. 2B shows a SEM image of the Ni/PVDF coaxial nanofiber membrane. FIG. 2C shows a SEM image of the Si/Ni/PVDF coaxial nanofiber membrane. FIG. 2D shows the TEM images of the Ni/PVDF coaxial nanofiber membrane. FIG. 2E shows TEM images of the Si/Ni/PVDF coaxial nanofiber membrane. FIG. 2F shows a TEM image of the Ni/PVDF coaxial nanofiber after folding or bending. Scale bar in FIG. 2A to C denote 2 μm; scale bar in FIG. 2D to F denote 200 nm. Scale bar of insert image in FIG. 2E denotes 50 nm.

FIGS. 3A-3I depict mechanical flexibility of a Si/Ni/PVDF nanofiber membrane anode disclosed herein. FIG. 3A shows surface topography of a PVDF nanofiber membrane. FIG. 3B is a photograph of the completely twisted PVDF membrane. FIG. 3C shows surface topography of a Ni/PVDF nanofiber membrane. FIG. 3D is a photograph of the folded Ni/PVDF membrane. FIG. 3E is a photograph of completely twisted Ni/PVDF membrane. FIG. 3F shows surface topography of the Si/Ni/PVDF nanofiber membrane. FIG. 3G is a photograph of the folded Si/Ni/PVDF membrane. FIG. 3H is a photograph of the stretched Si/Ni/PVDF membrane. FIG. 3I is a photograph of the completely twisted Si/Ni/PVDF membrane.

FIG. 4 is a graph showing a typical stress-strain curve of the Si/Ni/PVDF coaxial nanofiber membrane.

FIG. 5 is a graph showing X-ray diffraction spectra (XDS) of PVDF and Ni/PVDF nanofiber membrane, respectively.

FIG. 6 is a graph showing Raman spectra of Ni/PVDF and Si/Ni/PVDF nanofiber membrane, respectively.

FIG. 7A to D are graphs showing data relating to the electrochemical performance of the flexible membrane anode. FIG. 7A is a graph showing cyclic voltammogram curve of the flexible Si/Ni/PVDF coaxial nanofiber membrane. FIG. 7B is a graph showing charge/discharge capacity and coulombic efficiency vs. cycle number for the flexible Si/Ni/PVDF coaxial nanofiber membrane during galvanostatic charge/discharge between 0.05 V to 1.2 V at a rate of 0.2 C. FIG. 7C is a graph showing voltage profiles of the flexible Si/Ni/PVDF coaxial nanofiber membrane after 2, 10, 100, 200, 300, 400, 500 cycles at a rate of 0.2 C between 0.05 V to 1.2 V in half-cells. FIG. 7D is a graph showing rate capability of the flexible Si/Ni/PVDF coaxial nanofiber membrane anode.

FIG. 8 is a SEM image of flexible Si/Ni/PVDF coaxial nanofiber membrane after 200 cycles. Scale bar in the figure denotes 100 nm.

### DETAILED DESCRIPTION

Various embodiments refer to a nanofiber, which may be used to form an electrode such as an anode in lithium ion batteries. In embodiments disclosed herein, anodes formed with the nanofibers have demonstrated high charge/discharge capacity of 1850 mAh/g after 1000 cycles at 0.2 C—an improvement of more than five times that of commercial graphite anodes. In addition, anodes disclosed herein have excellent cycle stability, where capacity retention level of 58% after 1000 cycles has been demonstrated. This is a significant improvement over other anodes, which are only able to achieve cycles of less than 100 times.

The nanofibers in the electrode may be freestanding, meaning that use of polymer binders and/or conductive additives to prepare the electrode is not necessary. This further improves flexibility and cycle time performance of the electrode. The nanofibers and electrodes comprising the nanofibers may be manufactured using a simple, low cost process suitable for large scale manufacturing, and may be easily implemented in commercial battery manufacturing processes and adopted by battery manufacturers.

With the above in mind, various embodiments refer to a nanofiber. As used herein, the term “nanofiber” refers to an elongated or threadlike filament having a diameter in the order of nanometers.

The nanofiber comprises a polymeric fiber, a first layer comprising or consisting of an electrical conductor coated on the polymeric fiber, and a second layer comprising or consisting of an electroactive material selected from the group consisting of silicon, germanium, tin, and combinations thereof coated on the first layer. The first layer and/or the second layer is coaxial with the polymeric fiber, with the polymeric fiber forming the core of the nanofiber.

Advantageously, there are no particular limitations as to the type of polymers that may be used for forming the polymeric fiber. Oil-soluble polymer may generally be used to form the polymeric fibers disclosed herein. The polymeric fiber may be an electrical conducting polymer or an electrical non-conducting material. In various embodiments, the polymeric fiber is electrically non-conducting. In some embodiments, the polymeric fiber comprises or consists of a polymer selected from the group consisting of polyvinylidene fluoride (PVDF), polyacrylonitrile (PAN), polymethyl methacrylate (PMMA), polyurethane (PU), polyethylene terephthalate (PET), derivatives thereof, copolymers thereof, and combinations thereof. In specific embodiments, the polymeric fiber comprises or consists of polyvinylidene fluoride (PVDF).

The polymer may have a molecular weight in the range of about 100,000 to about 1,000,000. For example, molecular weight of the polymer may be in the range of about 200,000 to about 1,000,000, about 500,000 to about 1,000,000, about 700,000 to about 1,000,000, about 100,000 to about 800,000, about 100,000 to about 600,000, about 100,000 to about 400,000, about 300,000 to about 800,000, or about 400,000 to about 600,000.

Diameter of the polymeric fiber may be in the range of about 20 nm to about 1000 nm, such as about 20 nm to about 800 nm, about 20 nm to about 600 nm, about 20 nm to about 400 nm, about 20 nm to about 200 nm, about 20 nm to about 100 nm, about 50 nm to about 1000 nm, about 100 nm to about 1000 nm, about 200 nm to about 1000 nm, about 400 nm to about 1000 nm, about 600 nm to about 1000 nm, about 800 nm to about 1000 nm, about 200 nm to about 800 nm, about 400 nm to about 600 nm, or about 500 nm to about 900 nm.

The nanofiber comprises a first layer comprising or consisting of an electrical conductor coated on the polymeric fiber. The first layer may be deemed as a shell which at least substantially covers the polymeric fiber. In various embodiments, the first layer covers a surface or an external surface of the polymeric fiber completely.

In some embodiments, the electrical conductor comprises or consists of a metal selected from Group 10 and 11 of the Periodic Table of Elements. For example, the electrical conductor may comprise or consist of a metal selected from the group consisting of nickel, copper, silver, gold, and alloys thereof. In specific embodiments, the electrical conductor comprises or consists of nickel.

The first layer comprising or consisting of an electrical conductor is coaxial with the polymeric fiber. Thickness of the first layer that is formed on the polymeric fiber may be at least substantially uniform throughout the layer. In various embodiments, the first layer has a thickness in the range of about 50 nm to about 300 nm. For example, the first layer may have a thickness in the range of about 100 nm to about 300 nm, about 150 nm to about 300 nm, about 200 nm to about 300 nm, about 250 nm to about 300 nm, about 50 nm to about 250 nm, about 50 nm to about 200 nm, about 50 nm to about 150 nm, about 50 nm to about 100 nm, or about 100 nm to about 200 nm. Advantageously, the nanofiber disclosed herein is able to exhibit good mechanical flexibility even when a first layer having a thickness of 100 nm is coated thereon.

The nanofiber comprises a second layer comprising or consisting of an electroactive material selected from the group consisting of silicon, germanium, tin, and combinations thereof coated on the first layer. In various embodiments, the electroactive material comprises or consists of silicon.

Silicon is an inexpensive material as it is abundant in nature. It is also environmentally benign. In considering silicon as a material in practical applications, such as silicon anodes in lithium ion batteries, however, even though silicon has a high theoretical specific capacity of 4200 mAh/g and a low discharge potential, as well as a slightly higher voltage plateau than that of graphite to render its attractive safety characteristics, it has been difficult to adopt silicon in anodes in lithium ion batteries due to its shorter cycle life as compared to that of carbon-based materials, arising from its unstable solid electrolyte interface (SEI). This may be attributed to large volume changes (400%) of silicon during lithium insertion (lithiation) and extraction (delithiation) in charging/discharge, which constantly changes interface between the silicon and the electrolyte to prevent formation of a layer of stable SEI. This results in loss of capacity during battery cycling. Further, the large volume change also translates into higher incidence of mechanical fracture.

One or more of the above-mentioned problems may at least be alleviated by the nanofibers disclosed herein. For example, stress during charge/discharge cycles may be released through deformation of the nanofibers disclosed herein due to their flexibility. As binders and/or conductive additives are not necessary to prepare the nanofibers, the nanofibers may be freestanding. This further contributes to flexibility of the nanofibers. It has been demonstrated herein that lithium ion batteries containing an electrode formed using nanofibers disclosed herein exhibit stable cycle life over 1000 cycles. For example, anodes fabricated using the nanofibers disclosed herein have demonstrated a capacity that is greater than about 1850 mAh/g over a period of more than 1000 charge/discharge cycles. This is about six times higher than that of traditional graphite anodes.

The second layer comprising or consisting of an electroactive material selected from the group consisting of silicon, germanium, tin, and combinations thereof is coaxial with the polymeric fiber and the first layer. The second layer may at least substantially cover the first layer. In various embodiments, the second layer covers a surface or an external surface of the first layer completely.

Thickness of the second layer that is formed on the first layer may be at least substantially uniform throughout the layer. In various embodiments, the second layer has a thickness in the range of about 30 nm to about 500 nm. For example, the second layer may have a thickness in the range of about 50 nm to about 500 nm, about 100 nm to about 500 nm, about 200 nm to about 500 nm, about 300 nm to about 500 nm, about 400 nm to about 500 nm, about 30 nm to about 400 nm, about 30 nm to about 300 nm, about 30 nm to about 200 nm, about 100 nm to about 400 nm, about 20 nm to about 400 nm, or about 100 nm to about 300 nm.

As mentioned above, the first layer and/or the second layer is coaxial with the polymeric fiber. In various embodiments, the first layer and the second layer are independently concentric layers on the polymeric fiber, with the polymeric fiber forming the core of the nanofiber.

The nanofiber may contain multiple layers of the first layer and the second layer depending on intended application. For example, number of the coaxial nanofiber membrane layers may be increased to increase active mass loading or areal capacity. In various embodiments, a third layer comprising or consisting of an electrical conductor may be coated on the second layer, followed with a fourth layer comprising or consisting of an electroactive material selected from the group consisting of silicon, germanium, tin, and combinations thereof coated on the third layer. In use of the nanofiber as an anode, such as an anode in a lithium ion battery, for example, the electroactive material should form an external layer for contact with electrolyte present in the battery.

In specific embodiments, the nanofiber comprises a polymeric fiber comprising or consisting of polyvinylidene fluoride, a first layer comprising or consisting of nickel, and a second layer comprising or consisting of silicon.

Various embodiments also refer to a method of preparing a nanofiber. The method includes providing a polymeric fiber, coating a first layer comprising or consisting of an electrical conductor on the polymeric fiber, and coating a second layer comprising or consisting of an electroactive material selected from the group consisting of silicon, germanium, tin, and combinations thereof on the first layer. Examples of polymeric fibers, first layer and second layer that may be used have already been described above.

In various embodiments, providing a polymeric fiber comprises forming the polymeric fiber using a method selected from the group consisting of electrospinning, thermally induced phase separation, sea-island biocomponent spinning, molecular spinneret spinning, polymerization, and combinations thereof. In specific embodiments, providing a polymeric fiber comprises forming the polymeric fiber by electrospinning.

In electrospinning, fibers are formed by application of an electrical charge on a liquid to draw nano-fibers from the liquid. The process may comprise the use of a spinneret with a dispensing needle, a syringe pump, a power supply and a grounded collection device. Material to form the fibers may be present as a melt or a spinning solution in the syringe, and driven to the needle tip by the syringe pump where they form a droplet. When voltage is applied to the needle, a droplet is stretched to an electrified liquid jet. The jet is elongated continuously until it is deposited on the collector as a mat of fine fibers of nanometer sized dimensions.

Electrospinning affords control of the length of the resultant electrospun fibers by, for example, varying the voltage applied to the needle or by varying the composition of the melt or solution in the syringe. This may translate into improvement of mechanical properties of the fibers by controlling length of the fibers formed. Advantageously, long length of nanofibers may be formed and interconnected fiber network structures may be obtained. In various embodiments, optimal length of the nanofibers is 500 μm or more.

For example, length of the nanofibers may be in the range of about 500 μm to about 5000 μm, such as about 500 μm to about 4000 μm, about 500 μm to about 3000 μm, about 500 μm to about 2000 μm, about 500 μm to about 1000 μm, about 1000 μm to about 5000 μm, about 2000 μm to about 5000 μm, about 3000 μm to about 5000 μm, about 4000 μm to about 5000 μm, about 1000 μm to about 3000 μm, about 2000 μm to about 4000 μm, or about 2000 μm to about 3000 μm.

The method includes coating a first layer comprising or consisting of an electrical conductor on the polymeric fiber. In various embodiments, coating a first layer comprising or consisting of an electrical conductor on the polymeric fiber is carried out by electroless deposition.

As used herein, the term “electroless deposition” refers to a process for autocatalytic plating of an electrical conductor, such as metal. As its name implies, electroless deposition does not involve application of an electrical current to a work piece that is being coated. Instead, it involves use of an electroless plating solution containing a soluble form of the electrical conductor to be deposited, together with a reducing agent. In embodiments where the electrical conductor is a metal, the soluble form of the metal is usually an ionic species or a metal complex, such as a metal species coordinated to one or more ligands.

In the context of the present application, the electroless deposition process generally involves a seeding stage, where polymeric fibers are first immersed in a seeding solution for surface activation to form a catalytic surface. The catalytic surface may function to catalyze deposition of metal from solution. Once initiated, coating of the metal may continue by virtue of continued reduction of the solution metal source as catalyzed by its own metal surface. Advantageously, it has been demonstrated herein that directly coating electrical conductor such as metal particles onto electrospun polymer nanofibers using electroless deposition techniques yield nanofibers with high mechanical flexibility. Since the electrical conductor is coated on the fiber, they form highly efficient conductive channels to result in high conductivity of the nanofibers.

For illustration purposes only, activation of the nanofiber surface may, for example, be carried out by immersing a polymeric fiber such as a PVDF fiber in one or more seeding solutions. During the seeding process, the nanofiber membrane may first be immersed in an aqueous solution containing inorganic tin compounds, and subsequently in an aqueous solution containing inorganic palladium compounds. Examples of inorganic tin compounds that may be used include SnCl₂, SnCl₄, and/or SnHPO₄. The inorganic palladium compounds may be PbCl₂ and/or PbCl₄.

In some embodiments, the seeding solution may comprise a SnCl₂ aqueous solution and a PdCl₂ solution. Activation of the nanofiber surface may include immersing the polymeric fiber in the SnCl₂ aqueous solution, and subsequently in the PdCl₂ solution. In various embodiments, the SnCl₂ aqueous solution may have a concentration in the range of about 1.0 mM to about 30 mM, while the PdCl₂ solution may have a concentration in the range of about 1.0 mM to about 3.0 mM. The immersion time may be in the order of minutes, such as in the range of about 5 minutes to about 30 minutes for SnCl₂ aqueous solution and about 10 minutes for PdCl₂ solution. Palladium seeds may be formed on the polymeric fiber. Subsequently, the activated polymeric fiber may be immersed in a Ni(NO₃)₂ aqueous solution for electroless deposition to form a first layer of nickel on the polymeric fiber. The Ni(NO₃)₂ aqueous solution may have a concentration in the range of about 0.01 M to about 0.5 M. Time for the electroless deposition may be in the range of about 10 minutes to about 60 minutes.

In various embodiments, the first layer that is formed may have a rough surface to enhance interfacial adhesion between the polymeric fiber and a second layer that is coated on the first layer.

The method also includes coating a second layer comprising or consisting of an electroactive material selected from the group consisting of silicon, germanium, tin, and combinations thereof on the first layer. In various embodiments, the electroactive material comprises or consists of silicon.

Coating a second layer comprising or consisting of an electroactive material on the first layer may be carried out using a method selected from the group consisting of sputtering, RF magnetron sputtering, chemical vapor deposition, plasma-enhanced chemical vapor deposition, and combinations thereof.

The method disclosed herein is not limited to preparing of a single nanofiber, and may similarly apply for preparing a plurality of nanofibers. For example, a polymeric nanofiber network in the form of a membrane may be prepared by electrospinning. A first layer comprising or consisting of an electrical conductor may be coated on each of the polymeric nanofibers in the membrane. Subsequently, a second layer comprising or consisting of an electroactive material selected from the group consisting of silicon, germanium, tin, and combinations thereof may be coated on the first layer.

Various embodiments also refer to an electrode. The electrode comprises a nanofiber network, wherein the nanofiber network comprises a polymeric fiber network, wherein each polymeric fiber comprises a first layer comprising or consisting of an electrical conductor coated on the polymeric fiber, and a second layer comprising or consisting of an electroactive material selected from the group consisting of silicon, germanium, tin, and combinations thereof coated on the first layer.

In various embodiments, the long nanofibers are randomly oriented and form interconnected fibrous networks. Advantageously, the interconnected fibrous network of nanofibers may be directly used as a freestanding electrode. Volume density of the freestanding electrode may be in the range of about 0.1 g/cm³ to about 0.5 g/cm³. For example, volume density of the freestanding electrode may be in the range of about 0.2 g/cm³ to about 0.5 g/cm³, about 0.3 g/cm³ to about 0.5 g/cm³, about 0.4 g/cm³ to about 0.5 g/cm³, about 0.1 g/cm³ to about 0.4 g/cm³, about 0.1 g/cm³ to about 0.3 g/cm³, about 0.1 g/cm³ to about 0.2 g/cm³, or about 0.2 g/cm³ to about 0.4 g/cm³.

The electrode may be an anode. In various embodiments, the electrode is a silicon-based anode comprising a three dimension network microstructure formed with coaxial Si/Ni/polymer nanofibers membrane. Advantageously, by using electrospinning to form the nanofibers, the nanofibers may be fabricated at high throughput thereby facilitate manufacturing on a large scale commercial basis.

In various embodiments, the electrode is essentially free of at least one of a binder and a conductive additive. In specific embodiments, the electrode is free of a binder and/or a conductive additive. Advantageously, cycle performance of the electrode may be improved due to absence of the binder and/or conductive additive.

As mentioned above, the electrode may be in the form of a membrane comprising or consisting of polymeric fibers coated with an electrical conductor and an electroactive material. Electrical conductivity of the electrode may be the range of about 0.5 Ω/sq to about 50 Ω/sq. For example, electrical conductivity of the electrode may be the range of about 1 Ω/sq to about 50 Ω/sq, such as about 5 Ω/sq to about 50 Ω/sq, about 10 Ω/sq to about 50 Ω/sq, about 15 Ω/sq to about 50 Ω/sq, about 20 Ω/sq to about 50 Ω/sq, about 30 Ω/sq to about 50 Ω/sq, about 40 Ω/sq to about 50 Ω/sq, about 1 Ω/sq to about 40 Ω/sq, about 1 Ω/sq to about 30 Ω/sq, about 1 Ω/sq to about 20 Ω/sq, about 10 Ω/sq to about 40 Ω/sq, or about 15 Ω/sq to about 35 Ω/sq.

The electrode may be flexible. In various embodiments, the electrode is stretchable. It has been demonstrated herein that the electrode may be stretchable such that it may be stretched up to 16%, such as 15%, 14%, 13%, 12%, 11%, or 10%, of its original length without breaking.

In addition to the above mentioned, a polymeric nanofiber network membrane may be prepared. A first layer comprising or consisting of an electrical conductor may be coated on each of the polymeric nanofibers in the membrane. Subsequently, a second layer comprising or consisting of an electroactive material selected from the metal oxide group consisting of NiO, Co₃O₄, Mn₃O₄, and combinations thereof may be coated on the first layer.

In various embodiments, the nanofiber network membrane thus formed may be placed directly in a lithium ion battery to form an electrode. The electrode may be an anode in a lithium ion battery. The cathode of the lithium ion battery is not limited to any particular material, and conventional cathode materials in lithium ion batteries, such as LiCoO₂, LiMn₂O₄ and LiFePO₄ may be used. Electrolyte of the lithium ion battery may be a solution of lithium salt, such as a solution of 1.0 M LiPF₆ in 1:1 w/w ethylene carbonate/diethyl carbonate. In various embodiments, the lithium ion battery has a high specific capacity of greater than about 1850 mAh/g over a period of more than 1000 charge/discharge cycles.

In various embodiments, active mass loading can be increased to an areal capacity of 1 mAh/cm² by increasing the number of layers of the nanofiber membrane. For example, a stack of five layers of the membranes may achieve a high areal capacity of more than 1 mAh/cm². In various embodiments, each layer of the nanofiber membrane is electroactive and freestanding, hence a stack of the membrane layers arranged in any sequence is suitable for use in the battery.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### Experimental Section

Various embodiments relate to a technology of improving performance of or achieving high performance anodes in lithium ion batteries. The anode may be formed from Group IV semiconductor materials, such as silicon. The anode may be freestanding and flexible, for use in rechargeable flexible lithium ion batteries.

Various embodiments relates to a method of fabricating freestanding and flexible silicon/metal/polymer nanofibers anodes for high performance lithium ion batteries. In some embodiments, a PVDF nanofibers network membrane is prepared by electrospinning. A layer of nickel is coated onto the PVDF nanofibers to form nickel/(PVDF nanofiber) coaxial nanofibers membrane, and a layer of silicon is coated onto the nickel/(PVDF nanofiber) coaxial nanofibers to form high performance silicon anode.

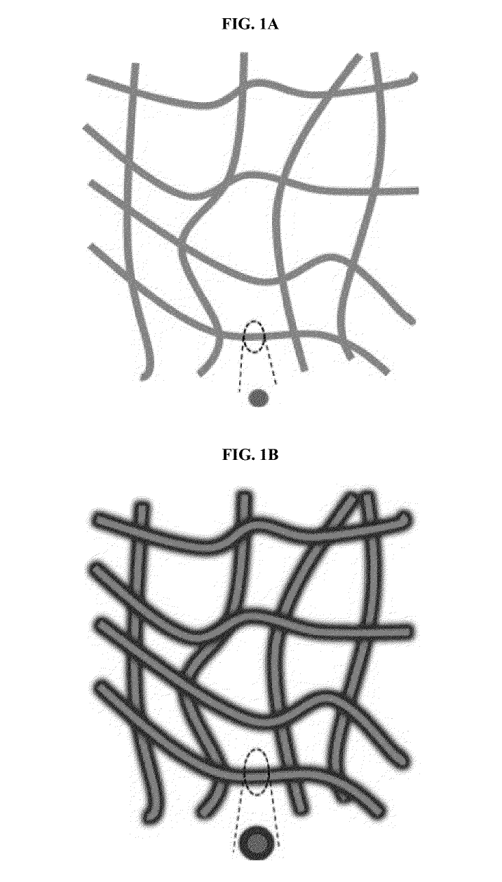

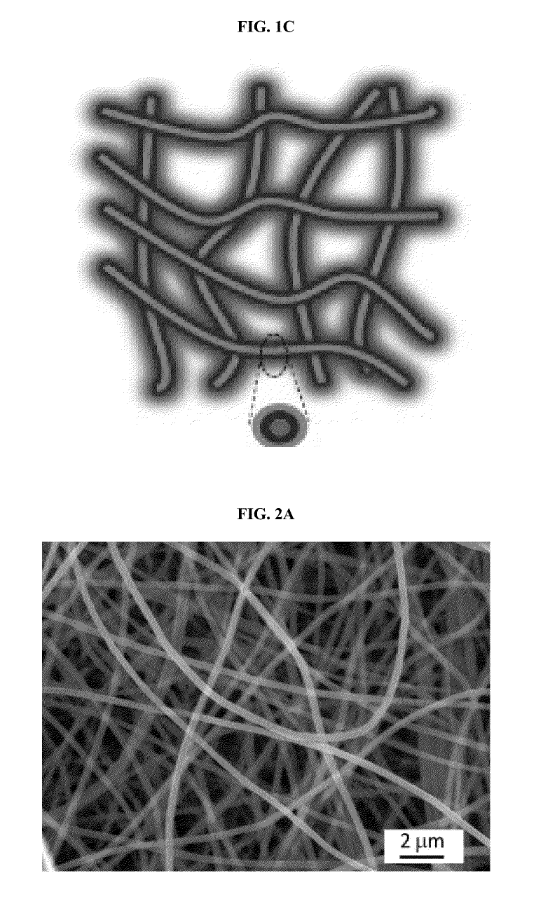

As one illustrative process of forming the freestanding and flexible coaxial nanofiber silicon anode in FIG. 1, a precursor solution is prepared by dissolving polyvinylidene fluoride (PVDF) in an organic solvent (mixture of acetone and DMF (30:70 vol %)) under stirring at a concentration of 10 wt %.

The precursor solution is electrospun at 15 cm distance (distance between the needle tip and the collector), 25 kV high voltage and 3 mL/h flow rate at room temperature. The nanofiber membranes are activated by introducing palladium seeds on the nanofiber surface. During the seeding process, the PVDF nanofiber membrane is first immersed in 3.0 mM SnCl₂ aqueous solution for 30 min and then in 3.0 mM PdCl₂ solution for 10 min.

The surface activated PVDF nanofiber membrane is immersed in 0.01 M Ni(NO₃)₂ aqueous solution for Ni electroless plating at 50° C. for about 15 min, to coat nickel on the PVDF nanofiber. The silicon material may be coated onto the nickel/PVDF coaxial nanofibers using a radio frequency (RF) magnetron sputtering system (ELITE RF/DC magnetron sputtering), where a pure silicon target (99.999%, Super Conductor Materials, Inc.) is sputtered using an RF sputterer at 200 W under pure Ar atmosphere.

The structural properties of Si/Ni/PVDF flexible nanofiber membrane anodes prepared were characterized using SEM, TEM and Raman spectroscopy.

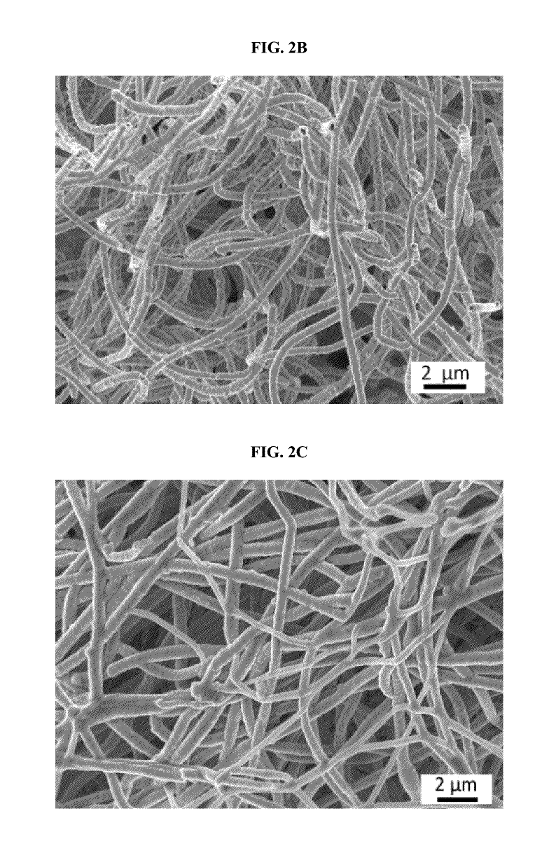

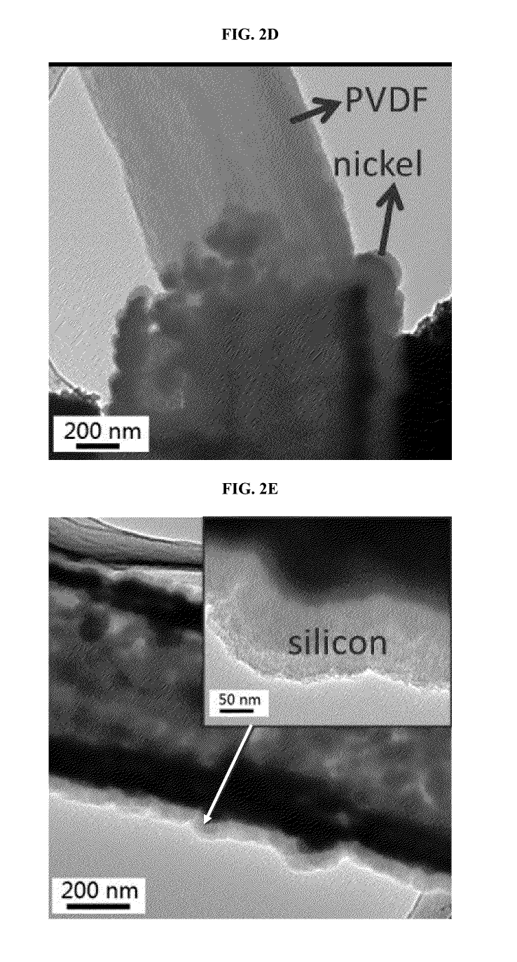

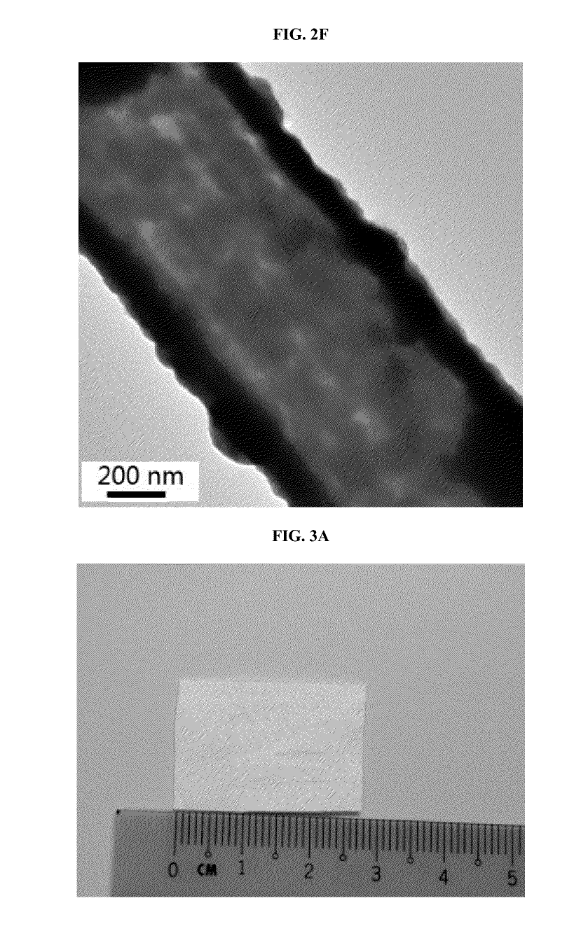

FIG. 2A shows an SEM image of PVDF nanofiber membrane. The PVDF nanofibers are randomly oriented, and average length of the nanofibers is up to hundreds of microns. SEM image of nickel/PVDF nanofiber coaxial nanofiber membrane is shown in FIG. 2B. In contrast to the pristine PVDF nanofibers, nickel coated nanofibers exhibit a rough surface that is likely caused by isotropic growth of nickel on nickel precursors attached to the catalyst seeds on the nanofibers. The rough surface may enhance interface adhesion between silicon shell and Ni/PVDF core.

FIG. 2D shows a TEM image of nickel/PVDF nanofiber coaxial nanofiber membrane. The TEM image of the coaxial Ni/PVDF nanofiber composite shows a uniform nickel coating with the thickness of around 100 nm around the PVDF nanofibers.

FIG. 5 shows an X-Ray diffraction spectrum of the Ni/PVDF nanofibers. Only the nickel diffraction peaks at 2θ=44.49°, 51.86°, and 76.41°, which correspond to Ni (111), Ni (200), and Ni (220), respectively, are observed. This suggests that the coated nickel is not oxidized.

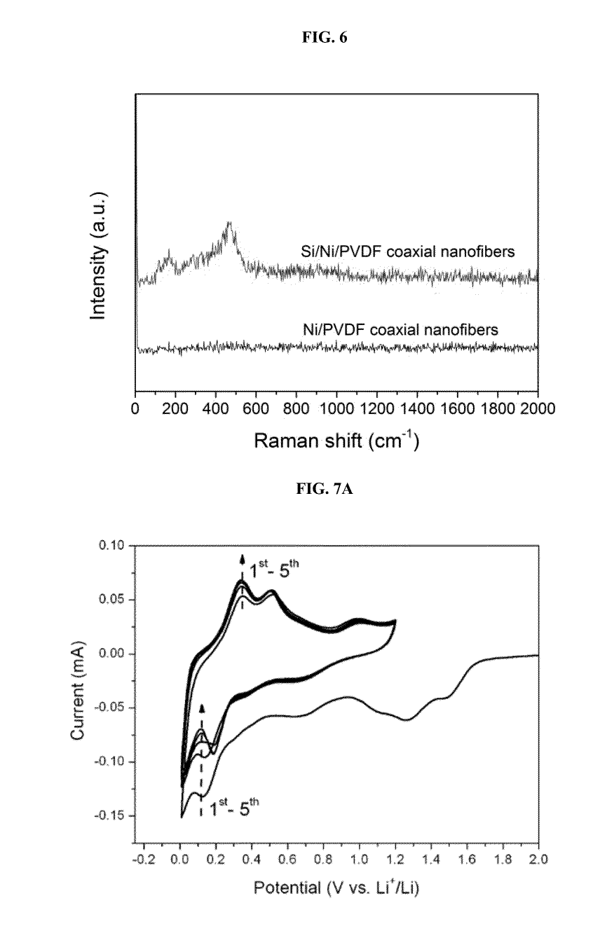

FIG. 2E shows that silicon coating on the surfaces of the Ni/PVDF coaxial nanofibers is essentially uniform throughout the membrane. Thickness of the coating silicon shell is about 80 nm. FIG. 6 shows the Raman spectrum of the Si/Ni/PVDF coaxial nanofibers membrane. Two silicon peaks at about 166 cm⁻¹ and 472 cm⁻¹, are detected, suggesting amorphous structures of the silicon coating.

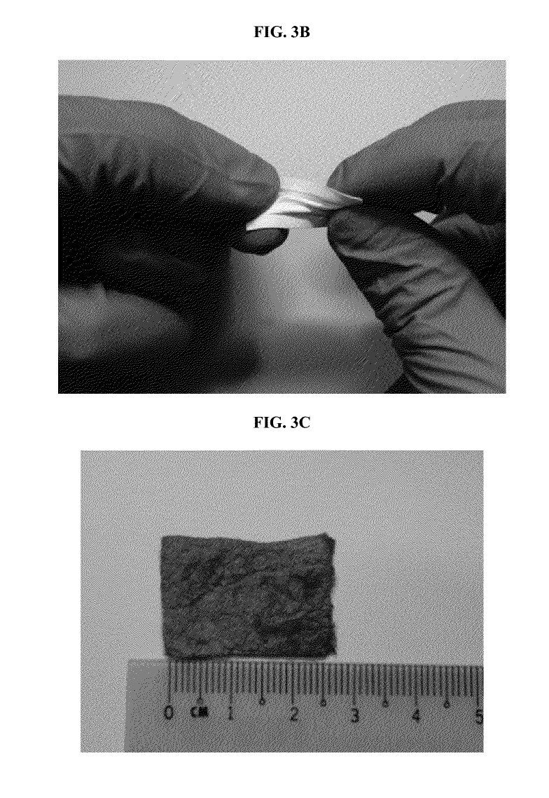

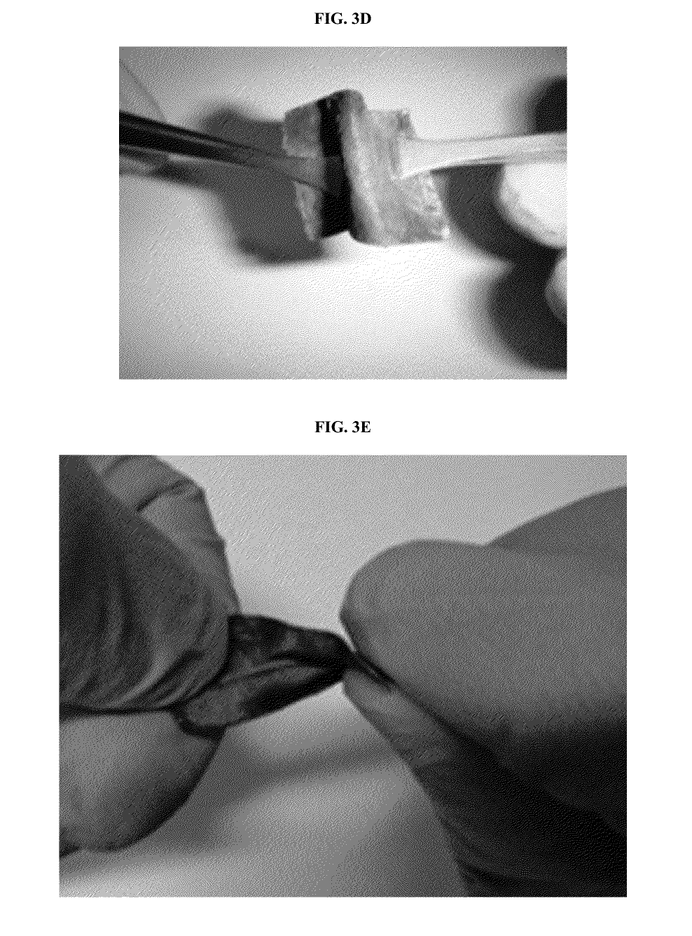

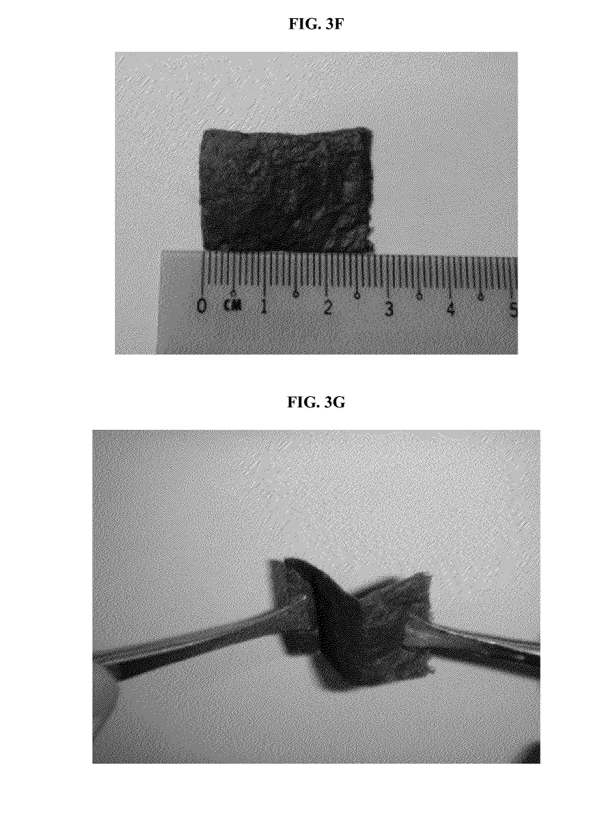

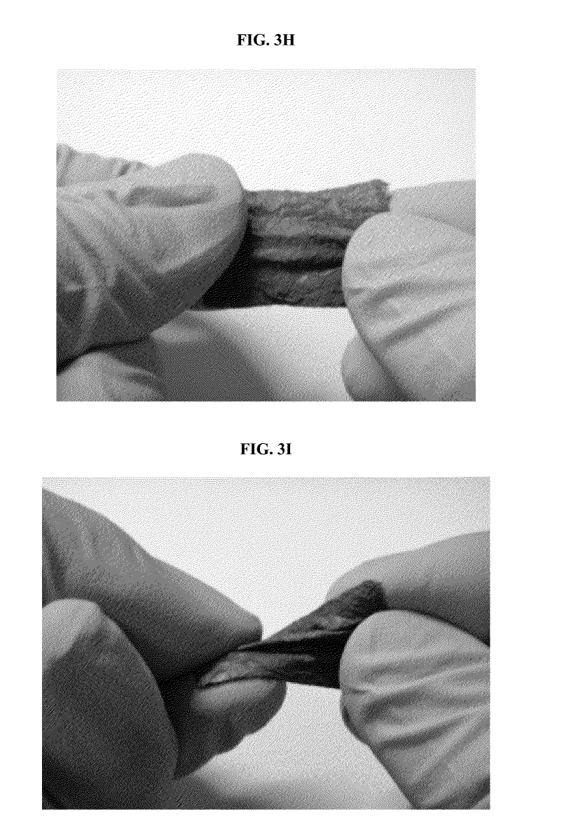

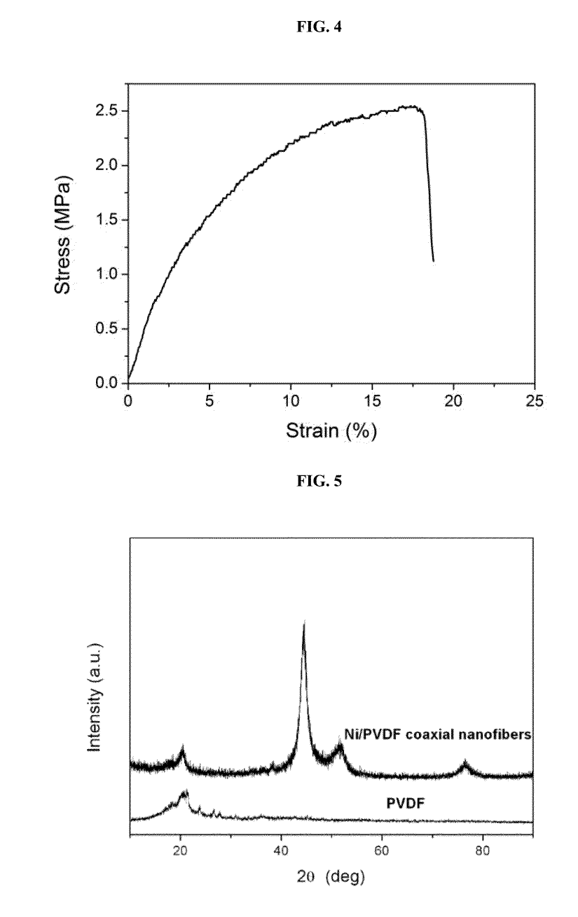

The Ni/PVDF membrane with 100 nm thick Ni coating has a high electrical conductivity of around 12 Ω/sq, determined using a four-point probe method when the thickness of nickel shell is 100 nm. FIG. 3D and FIG. 3E show that the Ni/PVDF nanofiber membrane possesses excellent mechanical flexibility even with a 100 nm thick nickel shell. After coating silicon on the Ni/PVDF coaxial nanofiber membrane, color of the membrane changed to light red. Shape of the membrane is able to restore after bending, folding, twisting and stretching. Conductivity of the Ni/PVDF membrane did not show a detectable degradation after bending, folding, twisting and stretching tests. As shown in FIG. 4, the plastic deformation testing under applied strain shows that it is able to recover to its initial form after stretching, and breaking of the flexible anode did not take place even with about 16% stretching.

According to one embodiment, the freestanding and flexible anode is formed by depositing the silicon onto the conductive coaxial nanofiber membrane.

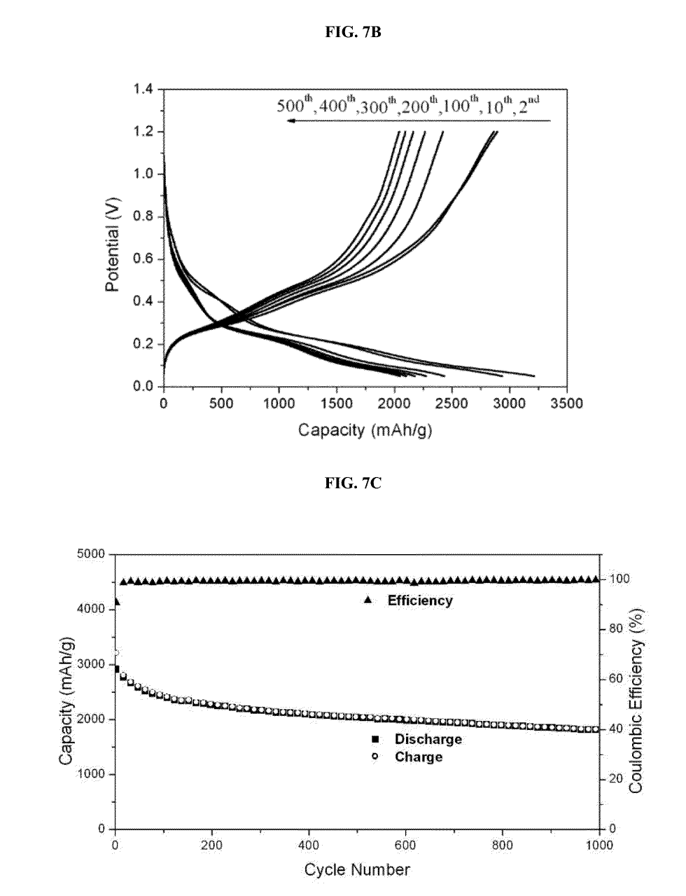

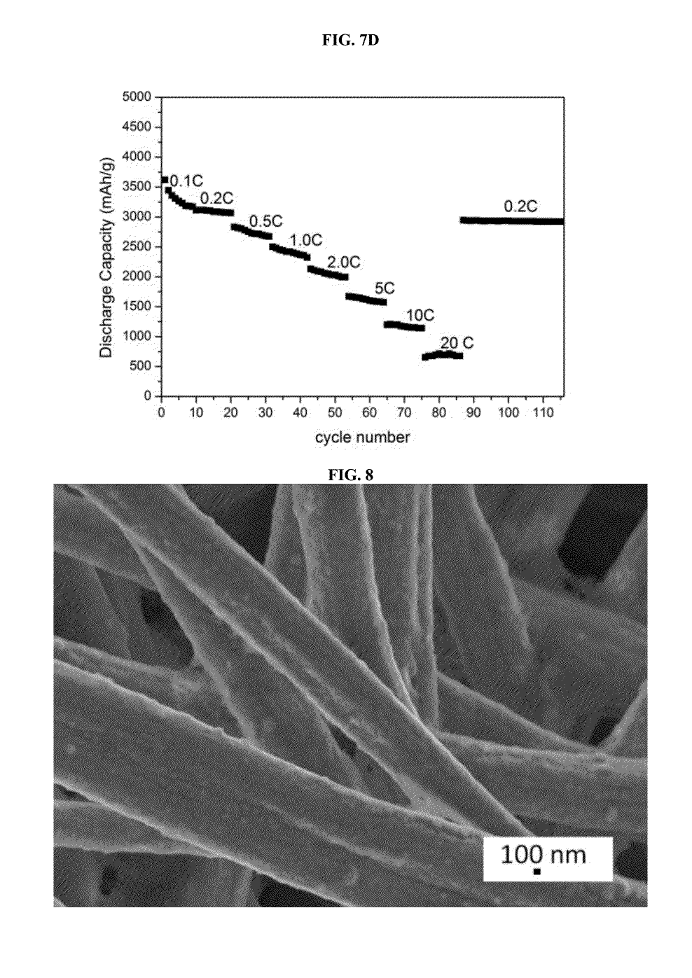

FIG. 7A illustrates the cyclic voltammetric characterization of the flexible silicon anode at 1 mV/S between 1.2 V and 0.05 V vs. Li/Li⁺. The flexible silicon anode shows reductive peaks located at 0.13 V and 0.65 V, respectively. During Li ion extraction process, two peaks located at 0.34 V and 0.51 V due to the de-lithiation of Li⁻ from silicon are observed. The current potential characteristics are consistent with those of amorphous silicon anodes. The shape of all curves in the oxidation branches remain almost unchanged for the first five cycles, indicating that the silicon coating is relatively stable and highly reversible in the delithiation reaction to some extent.

FIG. 7B illustrates the representative galvanostatic charge/discharge curve for the flexible silicon anode at a rate of 0.2 C. The lithiation potential shows a sloping profile between 0.290 V and 0.194 V, consistent with the behaviour of amorphous silicon.

FIG. 7C shows the storage capacity of the flexible silicon anode as a function of cycle number. It is seen that the flexible silicon anode retains a high capacity even after one thousand cycles (at 0.2 C) with a final specific capacity at about 1850 mAh/g.

FIG. 7D illustrates the cycling performance of flexible silicon anode at varying cycle rates between 0.1 C and 10 C. The flexible silicon anode shows a stability of capacity over these increasingly fast charging rates, indicating that increasing the rate of Li insertion/extraction has little effect on the structure of the anode.

FIG. 8 shows that the surface morphology of the flexible Si/Ni/PVDF coaxial nanofiber membrane after 200 cycles. Overall morphology of the nanofibers after 200 cycles of charge/discharge remains similar to that of freshly prepared Si/Ni/PVDF nanofibers. This proves also that the silicon coating is relatively stable. The process described herein may comprise any suitable functional electrode in a lithium ion battery.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A nanofiber comprising
a) a polymeric fiber;
b) a first layer comprising or consisting of an electrical conductor coated on the polymeric fiber; and
c) a second layer comprising or consisting of an electroactive material selected from the group consisting of silicon, germanium, tin, and combinations thereof coated on the first layer.

2. The nanofiber according to claim 1, wherein the polymeric fiber comprises or consists of a polymer selected from the group consisting of polyvinylidene fluoride (PVDF), polyacrylonitrile (PAN), polymethyl methacrylate (PMMA), polyurethane (PU), polyethylene terephthalate (PET), derivatives thereof, copolymers thereof, and combinations thereof.

3. The nanofiber according to claim 2, wherein the polymer has a molecular weight in the range of about 100,000 to about 1,000,000.

4. The nanofiber according to claim 1, wherein diameter of the polymeric fiber is in the range of about 20 nm to about 1000 nm.

5. The nanofiber according to claim 1, wherein the electrical conductor is selected from the group consisting of nickel, copper, silver, gold, and alloys thereof.

6. The nanofiber according to claim 1 wherein the first layer has a thickness in the range of about 50 nm to about 300 nm.

7. The nanofiber according to claim 1, wherein the electroactive material comprises or consists of silicon.

8. The nanofiber according to claim 1, wherein the first layer and the second layer are independently concentric layers on the polymeric fiber.

9. A method of preparing a nanofiber, the method comprising
a) providing a polymeric fiber;
b) coating a first layer comprising or consisting of an electrical conductor on the polymeric fiber; and
c) coating a second layer comprising or consisting of an electroactive material selected from the group consisting of silicon, germanium, tin, and combinations thereof on the first layer.

10. The method according to claim 9, wherein providing the polymeric fiber comprises forming the polymeric fiber using a method selected from the group consisting of electrospinning, thermally induced phase separation, sea-island biocomponent spinning, molecular spinneret spinning, polymerization, and combinations thereof.

11. The method according to claim 9, wherein coating the first layer comprising or consisting of the electrical conductor on the polymeric fiber is carried out by electroless deposition.

12. The method according to claim 9, wherein coating the second layer comprising or consisting of the electroactive material on the first layer is carried out using a method selected from the group consisting of sputtering, RF magnetron sputtering, chemical vapor deposition, plasma-enhanced chemical vapor deposition, and combinations thereof.

13. An electrode, comprising a nanofiber network, wherein the nanofiber network comprises a polymeric fiber network, wherein each polymeric fiber comprises:
a) a first layer comprising or consisting of an electrical conductor coated on the polymeric fiber; and
b) a second layer comprising or consisting of an electroactive material selected from the group consisting of silicon, germanium, tin, and combinations thereof coated on the first layer.

14. The electrode according to claim 13, wherein the electrode is essentially free of at least one of a binder and a conductive additive.

15. The electrode according to claim 13, wherein the electrode comprises a metal oxide selected from the group consisting of NiO, Co₃O₄, Mn₃O₄, and combinations thereof.

16. The electrode according to claim 13, wherein electrical conductivity of the electrode is in the range of about 0.5 Ω/sq to about 50 Ω/sq.

17. The electrode according to claim 13, wherein the electrode is stretchable such that it may be stretched up to 16% of its original length without breaking.

18. The electrode according to claim 13, wherein the electrode is an anode.

19. The electrode according to claim 13, wherein the electrode is an anode in a lithium ion battery.

20. The electrode according to claim 19, wherein the lithium ion battery has a capacity of greater than about 1850 mAh/g over a period of more than 1000 charge/discharge cycles.
